(19) United States
(12) Patent Application Publication
(10) Pub. No.: US 2022/0025669 A1
(43) Pub. Date: Jan. 27, 2022

(54) POOL PLATFORM DEVICE

(71) Applicant: ISWIM2 PTY LTD, Coombabah (AU)

(72) Inventors: Lyn MCDERMOTT, Murdunna (AU); Heath MCDERMOTT, Coombabah (AU)

(21) Appl. No.: 17/296,257

(22) PCT Filed: Nov. 29, 2019
(86) PCT No.: PCT/AU2019/051309

§ 371 Date: May 24, 2021

(30) Foreign Application Priority Data
Nov. 30, 2018 (AU) 2018904574

(51) Int. Cl. E04H 4/14

(52) U.S. Cl. CPC E04H 4/14

(57) ABSTRACT

A pool platform device comprising: a platform support which, in use, is configured to extend at least partially into the water of a pool; a platform adjustably mounted to the platform support, wherein in use, the platform is elevated above a floor of the pool such that a user can step up from the floor and onto the platform; and mounting means associated with the platform support and configured to releasably secure the device to a structure or feature of or associated with the pool.

The entire content of the specification of Australian provisional patent application no. 2018904574 is incorporated herein by reference.

### FIELD OF THE INVENTION

The present invention relates to a pool platform device.

### BACKGROUND

The depths of some pools, such as swimming pools, can vary from a relatively shallow end to a relatively deep end so as to suit people of various sizes and aquatic abilities. However, the shallower ends of a pool may not always be available or suitable for shorter and/or inexperienced swimmers. Meanwhile, the deeper ends may be too deep for such swimmers to confidently or safely swim in.

Conversely, some swimming pools are simply too deep and do not have shallower sections in which less experienced swimmers can safely swim.

Existing pool platform devices provide a platform that is elevated above the swimming pool floor. Swimmers can stand on the platform if they are distressed or wish to rest while keeping their heads above the water level.

However, the platforms of these existing devices are typically only suitable for pools with water levels of particular depths. Moreover, such devices cannot be readily adapted for people of different sizes.

Another shortcoming of these existing devices is that when they are placed in a pool, the movement of water therein (e.g. from human activity) can easily displace them.

Moreover, existing platform devices are relatively difficult to transport, and assembling them can be very time and labour-intensive. These devices can also be bulky and thus take up much-needed storage space that common pool dwellings and facilities do not have, in which case the devices are simply left on pool decks where they can become safety hazards.

Another difficulty associated with swimming is how to exit a swimming pool. Pools typically have one or more ladders via which a swimmer can exit the pool. However, the ladders may be inconveniently located, and/or there may be too few, in which case a swimmer would be required to expend additional energy just to reach a ladder—this can be particularly undesirable if the swimmer is already having trouble swimming.

Additionally, some pools may not have ladders or the like to assist swimmers with exiting the pool at the desired location. It can thus be difficult for a swimmer to exit the pool, especially if they are less physically able and/or are cannot stand on the swimming pool floor.

There is a need to address the above, and/or at least provide a useful alternative.

While the present disclosure refers generally to swimming pools, it is to be recognised that the present pool platform can be used with other pools, including hydrotherapy pools, physiotherapy rehabilitation pools and “learn to swim” pools.

### SUMMARY

According to a first aspect of the present invention, there is provided a pool platform device comprising:

a platform support which, in use, is configured to extend at least partially into the water of a pool;

a platform adjustably mounted to the platform support, wherein in use, the platform is elevated above a floor of the pool such that a user can step up from the floor and onto the platform; and

mounting means associated with the platform support and configured to releasably secure the device to a structure or feature of or associated with the pool.

In embodiments of the invention, the mounting means are configured to engage a coping of the pool.

In embodiments of the invention, the mounting means comprises one or more mounting plates configured to frictionally engage the pool coping.

In embodiments of the invention, an orientation of each mounting plate is adjustable so as to be substantially parallel and flush with an upper surface of the coping.

In embodiments of the invention, a lower surface of the or each mounting plate comprises an elastomeric pad configured to frictionally engage against an upper surface of the pool coping.

In embodiments of the invention, the mounting means further comprises one or more latching mechanisms for releasably securing the device to a grating of the pool.

In embodiments of the invention, the or each latching mechanism comprises at least one arm that is adjustably extendable relative to the platform support, the or each arm having a tooth configured to hook onto the grating.

In embodiments of the invention, a position of the platform relative to the platform support is adjustable such that a height of the platform above the pool floor can be varied.

In embodiments of the invention, the platform support comprises a frame to which the platform is pivotally engaged, the platform being movable between a support configuration, in which the user can step onto the platform, and a stowage configuration, in which the platform is folded towards the frame.

In embodiments of the invention, the platform is selectively lockable in the support and stowage configurations.

In embodiments of the invention, the device further comprises stabilising means configured to, in use, engage a sidewall of the pool to stabilise the device.

In embodiments of the invention, the device further comprises one or more wheels to facilitate transportation of the device.

In embodiments of the invention, the or each wheel is secured to the platform support by a respective mounting bracket, which bracket comprises the stabilising means.

In embodiments of the invention, the platform comprises apertures through which water can pass.

### BRIEF DESCRIPTION OF THE DRAWINGS

In order that the invention may be more easily understood, an embodiment will now be described, by way of example only, with reference to the accompanying drawings, in which:

FIG. 1 is a side perspective view of a pool platform device according to an embodiment of the present invention;

FIG. 2 is a side view of the device of FIG. 1 in a stowed configuration;

FIG. 3 is a side view of the device of FIG. 2 in a support configuration;

FIG. 4 is a close-up exploded view of a hinged connection of the device of FIG. 1;

FIG. 5 is a close-up side perspective view of a mounting means of the device of FIG. 1;

FIG. 6 is an exploded view of the mounting means of FIG. 5;

FIG. 7 is a side perspective view of a pool platform device according to another embodiment of the present invention; and

FIG. 8 is a front perspective view of a slider attachment of the platform device of FIG. 7.

### DETAILED DESCRIPTION

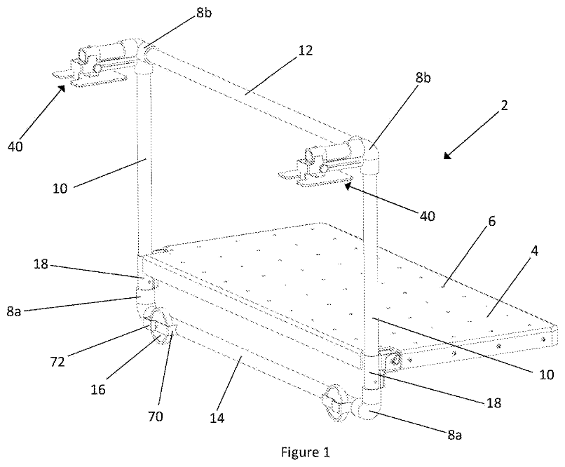

FIG. 1 shows a portable pool platform device 2 according to an embodiment of the present invention. The device 2 is configured to be releasably mounted to an edge of a swimming pool such that in use, the device 2 provides a submerged platform on which users can be supported. The device 2 thus provides a conveniently accessible platform for swimmers to rest or to assist swimmers with exiting the pool.

In the Figures, the device 2 comprises a substantially rectangular platform 4 comprising through-holes 6 through which water can flow. The through-holes 6 may be sufficiently large to allow users standing on the platform 4 to see through the through-holes 6 and visually inspect what is beneath the platform 4. The platform 4 may be formed from a lightweight, rustproof or rust-resistant metallic frame. An upper surface of the platform may be formed from or coated with a material with a sufficiently high coefficient of friction to help users maintain their grip on the platform 4.

The device 2 comprises a platform support to which the platform 4 is pivotally engaged. In the Figures, the platform support is depicted as a substantially rectangular frame formed from four hollow cylindrical tube sections 10, 12, 14 interconnected by elbows 8a, 8b at its corners, though the platform support can of course take other forms. The frame comprises a pair of laterally spaced and vertically extending tubes 10, an upper tube 12 and a lower tube 14 extending between the vertical tubes 10. The upper tube 12 provides a handle which users can hold on to when supported on the platform 4. The lower tube 14 carries a pair of laterally spaced apart wheels 16 oriented to allow for the device 2 to be wheeled in a direction parallel to its frame. The handle tube 12 can also be grasped to assist with moving and wheeling the portable pool platform device 2.

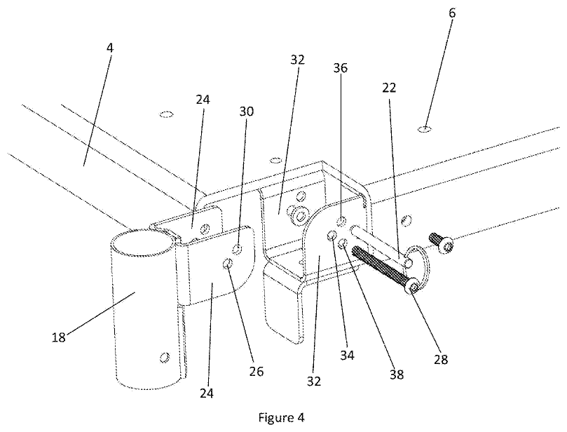

FIG. 3 shows the device 2 in a support configuration, wherein a securing pin 22 locks the platform 4 in a position in which it is substantially perpendicular to the lateral tubes 10. In this configuration, the platform 4 provides a stable surface on which swimmers can stand.

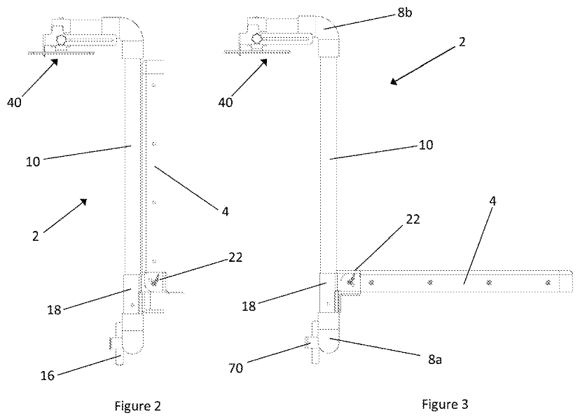

The device 2 can also be folded up for ease of transport and storage. To this end, the securing pin 22 can be removed to unlock the platform 4 from the support configuration. Referring to FIG. 2, the platform 4 can then be folded upwardly toward the frame so as to be adjacent and substantially parallel to the lateral tubes 10. The securing pin 22 can then be used to lock the platform 4 in place. With the device 2 in this stowed configuration, the device 2 occupies less space and allows for easy stowage thereof. It is also easier to stack and store two or more devices 2 when they are in the stowed configuration.

FIG. 4 shows a close-up exploded view of the hinged connection between the platform 4 and the platform support which allows the platform 4 to move between the stowed and support configurations. In this embodiment, a cylindrical connector element 18 is fitted over respective lower ends of each lateral tube 10. An exterior wall of the connector element carries a perpendicularly oriented clevis bracket, its wings 24 comprising a first through-hole 26 for receiving a rod or screw 28 about which the platform 4 is pivotable, and a second through-hole 30 for receiving the securing pin 22.

The platform 4 is configured to be mounted to the platform support via the respective clevis brackets of the connector elements 18. To this end, the front portion of each lateral end of the platform 4 also comprises a clevis bracket configured to receive the clevis bracket wings 24 of the connector element 18. The wings 32 of the platform's clevis bracket comprise a first through-hole 34 for receiving the screw 28 about which the platform 4 is pivotable. The wings 32 also comprise second and third through-holes 36, 38 for alternatingly receiving the securing pin 22.

To lock the device 2 in the support configuration, the platform 4 is lowered such that the second through-holes 36 of the platform's clevis bracket are aligned with the second through-holes 30 of the connector element 18. The securing pin 22 can then be passed through the aligned second through-holes 30, 36 to lock the platform 4 in place.

To lock the device 2 in the stowed configuration, the platform 4 is first unlocked from the support configuration by removing securing pin 22. The platform 4 is then pivoted upwardly about the screw 28 until the third through-holes 38 of the platform bracket are aligned with the second through-holes 30 of the connector element 18. The securing pin 22 can then be passed through these aligned through-holes 30, 38 to lock the platform 4 in place.

Of course, other means for pivoting the platform 4 and selectively locking its position are within the scope of the present disclosure.

Referring to FIG. 1, the device also comprises a pair of mounting means 40 associated with the platform support. In the depicted embodiment, the mounting means 40 extend from upper lateral corners of the frame and are configured to releasably secure the pool platform device 2 to a structure or feature of or associated with the pool.

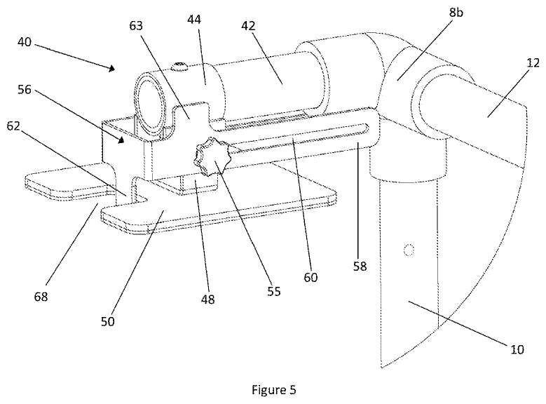

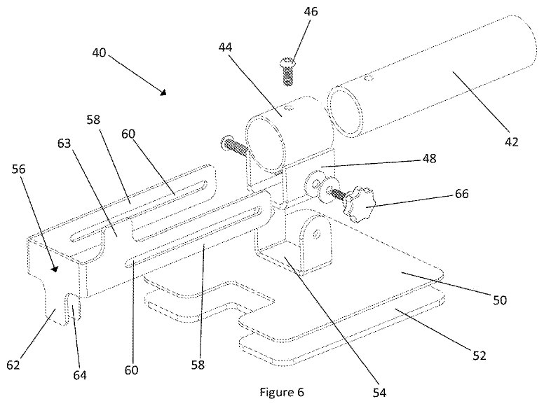

FIG. 5 shows a close-up view of an example mounting means. A 3-way elbow 8b forms each upper corner of the frame. One opening of the elbow 8b receives the upper handle tube 12, a second opening of the elbow 8b receives a lateral tube 10, and a third opening receives a mounting tube 42 to which the mounting means is secured.

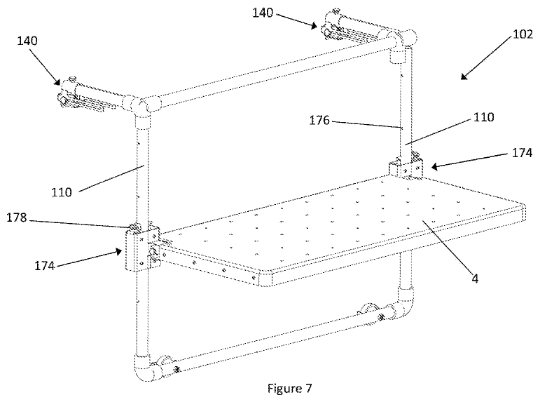

Referring to FIG. 6, the mounting means 40 comprises a collar 44 which fits over and is secured by a screw 46 to the mounting tube 42. A clevis bracket 48 is welded to a lower end of the collar 44 and provides an adjustable connection point via which the two mounting elements (discussed below) of the mounting means 40 are secured.

The first mounting element of the mounting means 40 takes the form of a flat mounting plate 50. The plate 50 is configured to frictionally engage an upper surface of the coping or other features which define a perimeter of a swimming pool. To this end, a lower face of the mounting plate comprises an elastomeric material 52 which helps grip onto the coping which is often wet. An upper surface of the mounting plate comprises a clevis bracket 54 configured to receive and be secured to the clevis bracket 48 of the collar 44.

The second mounting element comprises a latching mechanism 56 configured to latch onto grating or drainage commonly around the perimeter of a swimming pool. The mechanism 56 comprises two laterally opposed arms 58, each with a respective longitudinal slot 60. The arms 58 are connected to one another via a base segment which comprises a downwardly extending tab or tooth 62 configured to hook onto grating. An inner surface of the tooth 62 is provided with an elastomeric pad 64 or coating which helps the tooth 62 frictionally engage the grating. One of the arms also carries an upwardly extending tooth 63 configured to latch or secure to pool features which, for example, the downwardly extending tooth 62 may not be orientable to secure to, such as drainage or grating provided in the vertical sidewalls of a swimming pool.

When the mounting means 40 is assembled, the slots 60 of the arms 58 are aligned with the aligned through-holes of both clevis brackets 48, 54. An adjustment screw 66 is threaded through the slots 60 and both clevis brackets 48, 54. By adjusting the screw 66, the positions of both the mounting plate 50 and the latching mechanism 56 can be adjusted.

With reference to FIG. 5, the latching arms 58 are locked in a retracted position by the adjustment screw 66, and the tooth 62 is bordered by a recess 68 formed in a frontal portion of the mounting plate 50. To latch the device 2 to drainage or grating, the adjustment screw 66 simply needs to be loosened to allow the arms 58 to travel forward and away from the frame of the device 2 such that the tooth 62 can emerge from the recess 68 and hook onto grating. Loosening the adjustment screw 66 also allows the angle of the mounting plate 50 and the latching mechanism 56 to be adjusted to suit the angle of a pool coping or grating. For example, if grating or drainage is provided in a sidewall of a pool, the angle of the latching mechanism 56 can be adjusted so that it is substantially parallel with the sidewall of the pool, thereby allowing the tooth 62 to hook onto the grating.

Of course, the latching mechanism 56 can also hook over coping surfaces, such as joints between paving and tiles. The mechanism 56 can also hook over the edges of coping, even ones that are relatively narrow. For example, the coping can simply be clamped between the tooth 62 of the latching mechanism 56 and an opposing edge of the recess 68 of the mounting plate 50.

Referring to FIG. 1, the lower tube 14 of the device 2 is fitted with two wheels 16 which assist with transportation of the device 2. Each wheel 16 is mounted to the lower tube 14 via a wheel mount bracket 70. Each mount bracket 70 comprises a raised elastomeric pad portion 72 configured to engage a sidewall of the pool, thereby further stabilising the device 2 relative to the pool, particularly when a user is standing on the platform 4.

FIG. 7 shows a pool platform device 102 according to another embodiment of the present invention. The mounting means 140 assumes a different configuration but functions in a manner not dissimilar to the aforedescribed mounting means 40. In this embodiment, the platform is secured to the lateral tubes 110 such that the platform can travel up and down in a direction parallel to a longitudinal direction of the lateral tubes 110. In use, the height of the platform relative to the pool floor can thus be adjusted to suit pools of different depths and swimmers of different sizes. The platform 4 is secured to the lateral tubes 10 via a pair of slider mechanisms 174. Each slider mechanism 174 is configured to travel up and down a respective lateral tube 110. Each tube 110 has a series of regularly spaced adjustment through-holes 176 for receiving a securing pin 178 which can be used to releasably lock the slider mechanism 174 at a specific height along the lateral tubes 110. In this way, the height of the platform 4 above a pool floor can be adjusted simply by removing the securing pin 178 from a respective slider mechanism 174, moving the platform up or down the lateral tubes 110 to a desired height, and then locking the platform height by reinserting each securing pin 178.

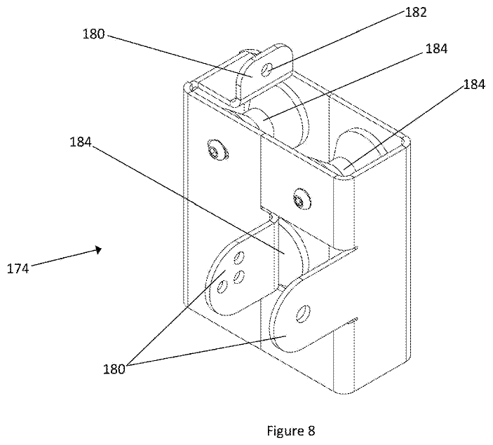

A close-up of the slider mechanism 174, in the form of a rectangular-shaped channel, is shown in FIG. 8. It comprises a pair of opposed flanges 180 carrying through-holes configured to pivotally engage the platform in a manner similar to that already described with reference to an earlier embodiment of the device 2. An upper end of the slider mechanism 174 carries a securing plate or bracket 182 comprising a through-hole 182 for receiving the securing pin 178. Disposed within the channel of the slider mechanism 174 are two pairs of opposed rollers 184. A respective lateral tube 110 is configured to be received between the opposed rollers 184 of each pair of rollers 184. In this way, the slider mechanism can roll up and down a respective lateral tube 110, thereby allowing the platform to move up and down along the lateral tubes 110.

Many modifications of the above embodiments will be apparent to those skilled in the art without departing from the scope of the present invention. For example, the platform support which the platform is pivotally secured to can take a wide range of different forms and need not be in the form of a rectangular frame. For example, in another embodiment, the platform support could comprise a single vertical bar, an upper end of which has a mounting means 40, and the platform 40 could be pivotally secured to a lower end of the bar. In other embodiments, the platform support could comprise one or more telescoping bars or tubes so as to allow adjustment of the size of the device and/or height of the platform above the pool floor.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A pool platform device comprising:
a platform support which, in use, is configured to extend at least partially into the water of a pool;
a platform adjustably mounted to the platform support, wherein in use, the platform is elevated above a floor of the pool such that a user can step up from the floor and onto the platform; and
a mounting means associated with the platform support and configured to releasably secure the device to a structure or feature of or associated with the pool.

2. The device of claim 1, wherein the mounting means is configured to engage a coping of the pool.

3. The device of claim 2, wherein the mounting means comprises one or more mounting plates configured to frictionally engage the pool coping.

4. The device of claim 3, wherein an orientation of the or each mounting plate is adjustable so as to be substantially parallel and flush with an upper surface of the coping.

5. The device of claim 4, wherein a lower surface of the or each mounting plate comprises an elastomeric pad configured to frictionally engage against an upper surface of the pool coping.

6. The device of claim 1, wherein the mounting means comprises one or more latching mechanisms for releasably securing the device to a grating of the pool.

7. The device of claim 6, wherein the or each latching mechanism comprises at least one arm that is adjustably extendable relative to the platform support, the or each arm having a tooth configured to hook onto the grating.

8. The device of claim 1, wherein a position of the platform relative to the platform support is adjustable such that a height of the platform above the pool floor can be varied.

9. The device of claim 1, wherein the platform support comprises a frame to which the platform is pivotally engaged, the platform being movable between a support configuration, in which the user can step onto the platform, and a stowage configuration, in which the platform is folded towards the frame.

10. The device of claim 9, wherein the platform is selectively lockable in the support and stowage configurations.

11. The device of claim 1, further comprising a stabilising means configured to, in use, engage a sidewall of the pool to stabilise the device.

12. The device of claim 11, further comprising one or more wheels to facilitate transportation of the device.

13. The device of claim 12, wherein the or each wheel is secured to the platform support by a respective mounting bracket, which mounting bracket comprises the stabilising means.

14. The device of claim 1, wherein the platform comprises apertures through which water can pass.
